(19) United States
(12) Patent Application Publication
(10) Pub. No.: US 2009/0190006 A1
(43) Pub. Date: Jul. 30, 2009

(54) Methods, systems and apparatuses for pixel signal correction using elliptical hyperbolic cosines

(76) Inventors: Anthony R. Huggett, Basingstoke (GB); Graham Kirsch, Tadley (GB)

Correspondence Address: DICKSTEIN SHAPIRO LLP, 1825 EYE STREET NW, Washington, DC, 20006-5403, US

(21) Appl. No.: 12/071,246

(22) Filed: Feb. 19, 2008

(30) Foreign Application Priority Data
Jan. 25, 2008 (GB) 0801443.3

(51) Int. Cl. H04N 5/217

(52) U.S. Cl. 348/241

(57) ABSTRACT

Methods, systems and apparatuses for correcting the sensitivity of pixel signals, the pixel signal correction values being determined based on an elliptical hyperbolic cosine function. The function may further be a rotated elliptical hyperbolic cosine function or a polynomial derived from the rotated elliptical hyperbolic cosine function. Using these functions to represent the correction values in memory allows for on-chip storage of the means to determine the correction values.

### FIELD OF THE INVENTION

Embodiments of the invention relate generally to image processing and more particularly to approaches for adjusting signal values from an array of pixels.

### BACKGROUND

Imagers, for example CCD, CMOS and others, are widely used in imaging applications, for example, in digital still and video cameras. A pixel array is made up of many pixels arranged in rows and columns. Each pixel senses light and forms an electrical signal corresponding to the amount of light sensed. To capture a digital representation of light entering the camera based on an image, circuitry converts the electrical signals from each pixel to digital values and stores them. Each of these stored digital values corresponds to a component of the viewed image entering the camera as light.

In an ideal digital camera, each pixel in the array behaves identically regardless of its position in the array. As a result, all pixels should have the same output value for a given light stimulus. For example, consider an image of a scene of uniform radiance. Because the light intensities of each component of such an image is equal, if an ideal camera photographed this image, each pixel of a pixel array would generate the same output value.

Actual digital cameras, however, do not behave in this ideal manner. When a digital camera photographs a scene of uniform radiance, the signal values read from the pixel array are not necessarily equal. For example, the array in a typical digital camera might generate pixel signal values such that pixel signals from portions near the outside of the array are darker than pixel signals from the center portion of the image, even though the outputs should be uniform.

It is well known that for a given optical lens used with a digital still or video camera, the pixels of the pixel array will generally have varying signal values even if the imaged scene is of uniform radiance. The varying responsiveness depends on a pixel's spatial location within the pixel array. One source of such variations is lens shading. Lens shading can cause pixels in a pixel array located farther away from the center of the pixel array to have a lower value when compared to pixels located closer to the center of the pixel array, when the camera is exposed to a scene of uniform radiance. Other sources may also contribute to variations in a pixel value with spatial location, and more complex patterns of spatial variation may also occur.

Such variations in a pixel value can be compensated for by adjusting, for example, the gain applied to the pixel values based on spatial location in a pixel array. For lens shading adjustment, for example, it may happen that the farther away a pixel is from the center of the pixel array, the more gain is needed to be applied to the pixel value. In addition, sometimes an optical lens is not centered with respect to the optical center of the imager; the effect is that lens shading may not be centered at the center of the imager pixel array. Other types of changes in optical state and variations in lens optics may further contribute to a non-uniform pixel response across the pixel array. For example, variations in iris opening or focus position may affect a pixel value depending on spatial location.

Variations in a pixel value caused by the spatial position of a pixel in a pixel array can be measured and the pixel response value can be adjusted with a pixel value gain adjustment. Lens shading, for example, can be adjusted using a set of positional gain adjustment values, which adjust pixel values in post-capture image processing. With reference to positional gain adjustment to compensate for shading variations with a fixed optical state/configuration, gain adjustments across the pixel array can typically be provided as pixel signal correction values, one corresponding to each of the pixels. The set of pixel signal correction values for the entire pixel array forms a gain adjustment surface for each of a plurality of color channels. The gain adjustment surface is applied to pixels of the corresponding color channel during post-capture image processing to correct for variations in pixel values due to the spatial location of the pixels in the pixel array.

The required correction will have an approximately symmetrical form, although the center of symmetry is not necessarily the center of the image. Moreover, the center for each color channel may not be in exactly the same place, and the asymmetry for each field may be different.

Thus, lens correction logic needs to be calibrated for the position of the lens with respect to the die. Conceivably, this calibration needs to be performed individually for every module (chip and lens combination) produced. However, if the calibration data cannot be stored in non-volatile memory on the module, it must be associated with the module throughout the manufacturing process until it can be programmed into off-module non-volatile memory, which adds significant inconvenience and cost to the manufacturing process.

Therefore, it is not cost-effective to calibrate and store the gain of every pixel individually. Rather, the required gain may be described as a mathematical surface, which can be created on the fly by a logic circuit from a set of parameters. One such method that uses a polynomial function to describe the gain adjustment surface is described in copending application Ser. No. 11/512,303, entitled METHOD, APPARATUS, AND SYSTEM PROVIDING POLYNOMIAL BASED CORRECTION PIXEL ARRAY OUTPUT, filed on Aug. 30, 2006. This approach allows a very large degree of flexibility, having the capacity to model the asymmetry and hence gives good correction, but still requires a relatively large number of parameters. Horizontally, the gain is represented as a fourth order polynomial, which requires five parameters. Each of these parameters is derived vertically from fourth order polynomials each of which has five terms and there are 4 color channels, so the total storage requirement is 100 (16-bit) coefficients.

Accordingly, there exists a need for a method and system that allows for generation of an adjustment surface from stored values that has a reduced storage requirement. There further exists a need for a method and system that allows the information necessary for calculating the adjustment surface to be stored on the chip of the imager.

### BRIEF DESCRIPTION OF THE DRAWINGS

FIG. 1 is a is a diagram showing the basic components of a pixel signal correction process flow.

FIG. 2 is a flowchart showing the pixel signal correction process performed by an image processor.

FIG. 3 is a gain surface resulting from a method in accordance with a disclosed embodiment.

FIG. 4 is a block diagram of a circuit implementation of a method in accordance with a disclosed embodiment.

FIG. 5 is a gain surface resulting from a method in accordance with a disclosed embodiment.

FIG. 6 is a block diagram of a circuit implementation of a method in accordance with a disclosed embodiment.

FIG. 7 is a block diagram of a circuit implementation of a method in accordance with a disclosed embodiment.

FIG. 8 is an illustration of the shapes of the rotated elliptical correction functions, overlaid for comparison

FIG. 9 is a block diagram of an imager constructed in accordance with disclosed embodiments.

FIG. 10 is a processor system employing the imager of FIG. 9.

### DETAILED DESCRIPTION

In the following detailed description, reference is made to the accompanying drawings which form a part hereof, and in which are shown, by way of illustration, specific embodiments. These embodiments are described in sufficient detail to enable those skilled in the art to make and use them, and it is to be understood that structural, logical or procedural changes may be made. Particularly, in the description below, processes are described by way of flowchart. In some instances, steps which follow other steps may be reversed, be in a different sequence or be in parallel, except where a following procedural step requires the presence of a prior procedural step. The disclosed processes may be implemented by an image processing pipeline which may be implemented by digital hardware circuits, a programmed processor, or some combination of the two. Any circuit which is capable of processing digital image pixel values can be used.

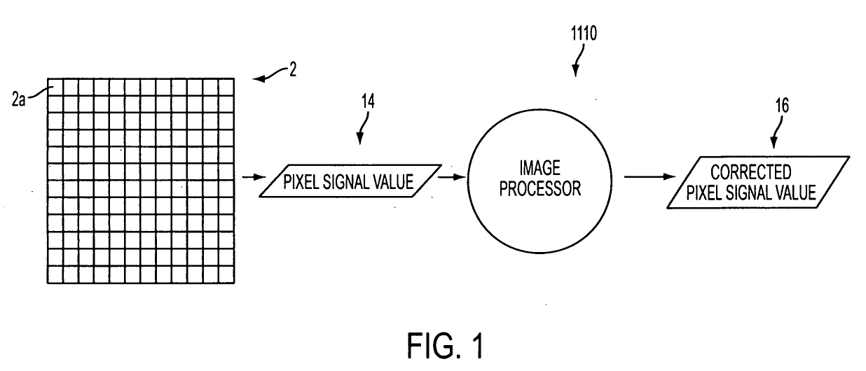

FIG. 1 is a diagram showing the basic components of a pixel correction process flow. FIG. 1 shows a portion of an image processor 1110 capable of acquiring values generated by pixels 2a in a pixel array 2 and performing operations on the acquired values to provide corrected pixel values. The operations performed by image processor 1110 are in accordance with disclosed embodiments as described in further detail below. As one non-limiting example, the embodiment may be used for positional gain adjustment of pixel values to adjust for different lens shading characteristics.

Any type of image processor 1110 may be used to implement the various disclosed embodiments, including processors utilizing hardware including circuitry, software storable in a computer readable medium and executable by a microprocessor, or a combination of both. The embodiments may be implemented as part of an image capturing system, for example, a camera, or as a separate stand-alone image processing system which processes previously captured and stored images. Additionally, one could apply the embodiments to pixel arrays using any type of technology, such as arrays using charge coupled devices (CCD) or using complementary metal oxide semiconductor (CMOS) devices, or other types of pixel arrays.

As illustrated by FIG. 1, image processor 1110 acquires at least one pixel signal value 14 from pixel array 2 and then determines and outputs at least one corrected pixel signal value 16. Image processor 1110 determines a corrected pixel signal value 16 based, for example, on the pixel's 2a position in the array 2. It is known that the amount of light captured by a pixel near the center of the array is greater than the amount of light captured by a pixel located near the edges of the array due to various factors, such as lens shading.

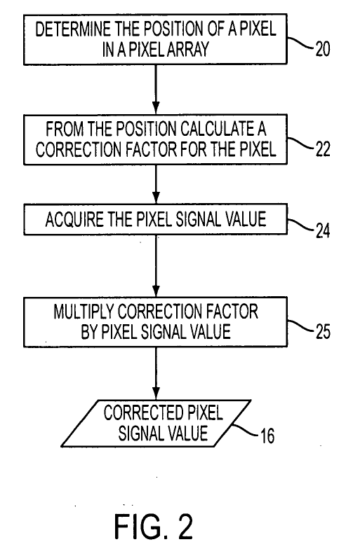

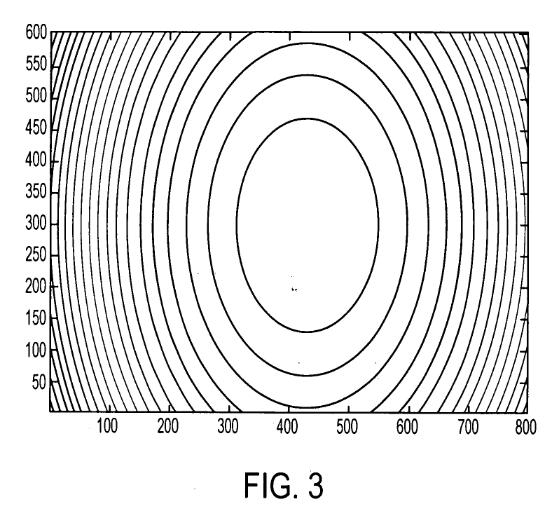

The overall process performed by image processor 1110 is illustrated in FIG. 2. At step 20, the position of an incoming pixel signal value in the array is determined, the position corresponds to a row value and a column value. Based on the row and column values, image processor 1110 determines a correction factor for the pixel signal value (step 22). Once the image processor 1110 determines the correction factor, it calculates a corrected pixel signal value 16 by multiplying an acquired pixel signal value (step 24) by the calculated correction factor (step 25) as follows:

SV_{corrected}=SV_{acquired}×Correction_factor (1)

The correction factor of the disclosed embodiments is determined using functions based on the hyperbolic cosine of an elliptical radius. The center, size and orientation of the ellipse are parameters determined during calibration (described later) for a given imager and lens combination.

The hyperbolic cosine function, hereafter referred to as “cosh,” is defined as follows:

$$cosh x = cos j x = {\sum }_{n = 0}^{∞} \frac{{x}^{2 n}}{( 2 n ) !} = 1 + \frac{{x}^{2}}{2} + \frac{{x}^{4}}{24} + \frac{{x}^{6}}{720} + Λ \qquad ( 2 )$$

For the purposes of simplification of a hardware implementation of the disclosed embodiments, the cosh function is approximated by truncating its Taylor series to the first two non-constant terms:

$$cosh ( x ) = 1 + \frac{{x}^{2}}{2} + \frac{{x}^{4}}{24} + \frac{{x}^{6}}{720} + Λ \approx 1 + \frac{{x}^{2}}{2} + \frac{{x}^{4}}{24} ; \qquad ( 3 )$$

For the range of interest, the underestimation of cosh(x) caused by this approximation is small and the approximation allows for smaller hardware requirements.

In order to scale and center the function according to the characteristics of the lens system, at least two parameters are needed per dimension and they are determined during a trial-and-error calibration process. Assuming g(x) to be the required gain at a position x in the x-direction, then g(x)=cosh(sₓ(x−cₓ)), where sₓ is a constant scaling factor in the x-direction and cₓ is a constant center value in the x-direction. For a two-dimensional image, the same constants are needed in the y-direction and the constant values s_{y} and c_{y} are also determined by the calibration process.

“Elliptical Cosh” Gain Adjustment Approximation:

In one disclosed embodiment, the positional gain adjustment surface is approximated as the hyperbolic cosine of the radius of an ellipse with its major and minor axes aligned along the x- and y-axes. This method is referred to herein as the “elliptical cosh” method. An example of a gain surface resulting from the elliptical cosh method is shown in FIG. 3. The gain for a particular pixel (x,y) using the “elliptical cosh” method is determined in accordance with Equation (4):

$$cosh ( r ) \approx 1 + \frac{{r}^{2}}{2 !} + \frac{{r}^{4}}{4 !} = 1 + \frac{{( {s}_{x} ( x - {c}_{x} ) )}^{2} + {( {s}_{y} ( y - {c}_{y} ) )}^{2}}{2} + \frac{{( {( {s}_{x} ( x - {c}_{x} ) )}^{2} + {( {s}_{y} ( y - {c}_{y} ) )}^{2} )}^{2}}{24} ; \qquad ( 4 )$$

where r is the radius of the ellipse, sₓ is the constant scaling factor in the x-direction, cₓ is the constant center value in the x-direction, s_{y} is the constant scaling factor in the y-direction and c_{y} is the constant center value in the y-direction. It should be noted that the values of cₓ and c_{y} are based on the center of the correction surface for the image, and not necessarily on the center of the image array itself.

As shown above in Equation (4), the value of the radius of the ellipse is determined in accordance with Equation (5):

r²=(sₓ(x−cₓ))²+(s_{y}(y−c_{y}))² (5)

This radius equation results in a correction surface of an ellipse with its major and minor axes aligned along the x- and y-axes.

As can be seen in FIG. 3, using the elliptical cosh method of approximating positional gain adjustment values results in a positional gain adjustment surface containing values that get monotonically larger towards the edge in every direction; thereby the largest values occur at the corners of the image. The contours of the positional gain adjustment surface generated using the elliptical cosh method remain elliptical as the gain increases towards the corners. Further, the major and minor axes of the ellipse will always coincide with the x- and y-axes directions of the image.

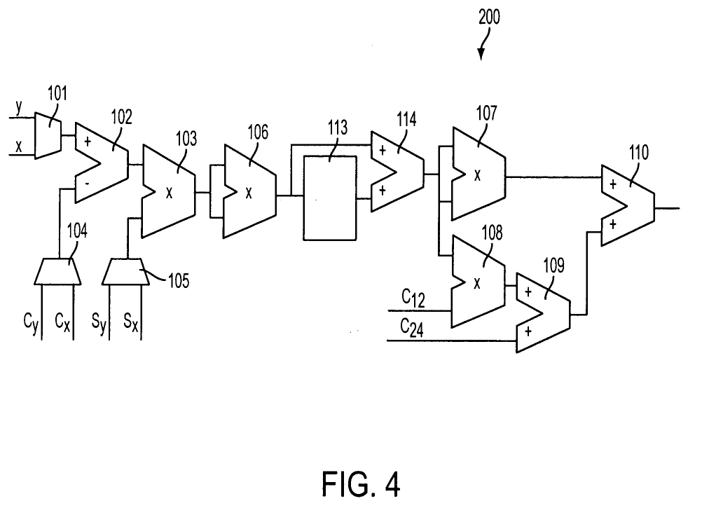

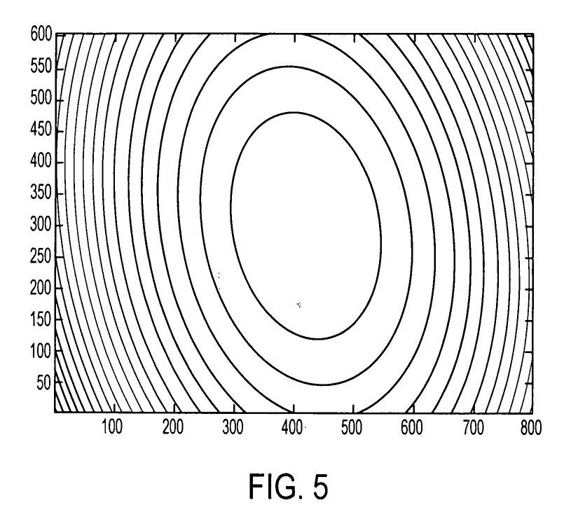

FIG. 4 illustrates a block diagram of an example circuit 200 implementing the elliptical cosh method of the disclosed embodiment. The circuit 200 contains three multiplexers 101, 104, 105, a subtractor 102, three adders 109, 110, 114, four multipliers 103, 106, 107, 108, and a register 113. Inputs c_{y}, cₓ, sₓ, s_{y} are the constant values discussed above and determined in accordance with a trial-and-error calibration method. Inputs c₁₂ and c₂₄ are also constants and have a value of 12 and 24 respectively in the embodiments disclosed herein, but are not limited to such values. Input y is the number of the row in which the pixel is located, i.e., the vertical position of the pixel within the image. Input x is the number of the column in which the pixel is located, i.e., the horizontal position of the pixel within the image.

Assuming a monochrome line-by-line image scan, the operation of the circuit 200 is now described. At the start of the readout of each row, during the horizontal blanking period, multiplexers 101, 104 and 105 are controlled so that they are all in the y-position. The output of subtractor 102 is then (y−c_{y}) and the output of multiplier 103 is (s_{y}(y−c_{y})). Multiplier 106 squares this result (e.g., s_{y}²(y−c_{y})²) and the squared result is input into register 113, where it is held for the active part of the line. In the active data period, the three multiplexers 101, 104, 105 are switched to the x-position. Subtractor 102 and multipliers 103 and 106 work to produce the square of the scaled offset x value (e.g., sₓ²(x−cₓ)²) in the same manner in which the scaled offset y value is determined. The two squared values are then added together in adder 114 yielding the value of r² (e.g., sₓ²(x−c_{y})²+s_{y}²(y−c_{y})²) as shown in Equation (5). The output of adder 114 is input into both inputs of multiplier 107 producing the 4th power of the radius (r⁴) and simultaneously into constant multiplier 108, which multiplies the squared term by the constant c₁₂. The output from multiplier 108 is added to constant c₂₄ in adder 109, the output of which is added to the output of multiplier 107 in adder 110. The output of adder 110 is thus (r⁴+c₁₂(r)²+c₂₄) where r₂ is as shown in Equation (5). The output of adder 110 is the positional gain adjustment value for the pixel located at (x,y) and is multiplied by the value of the pixel signal in accordance with Equation (1), resulting in the corrected pixel signal value.

“Rotated Elliptical Cosh” Gain Adjustment Approximation:

In another disclosed embodiment, the positional gain adjustment surface is approximated as the hyperbolic cosine of the radius of an ellipse with its major and minor axes not aligned along the x and y axes. This method is referred to herein as the “rotated elliptical cosh” method. An example of a gain surface resulting from the rotated elliptical cosh method is shown in FIG. 5. For the rotated elliptical cosh method, an extra term is introduced into the radius equation that allows the axes to be rotated away from the x and y axes. The radius is instead calculated in accordance with Equation (6):

r²=(sₓ(x−cₓ))²+(s_{y}(y−c_{y}))²+s_{xy}sₓs_{y}(x−cₓ)(y−c_{y}); (6)

where r is the radius of the ellipse, sₓ is the constant scaling factor in the x-direction, cₓ is the constant center value in the x-direction, s_{y} is the constant scaling factor in the y-direction and c_{y} is the constant center value in the y-direction. The term s_{xy} is a constant scaling factor that acts to move the axes of the ellipse away from the x- and y-axes. It should again be noted that cₓ and c_{y} are based on the center of the correction surface for the image, but not necessarily on the center of the image array itself.

Positive values of the additional s_{xy} constant have the effect of reducing the gain (and hence pulling the contours of the positional gain adjustment surface) towards the top right and bottom left of the image. Negative values of the additional s_{xy} constant have the effect of reducing the gain (and hence pulling the contours of the positional gain adjustment surface) towards the top left and bottom right of the image. By setting the values sₓ, s_{y} and s_{xy} appropriately (during the calibration procedure), an ellipse of arbitrary rotation and eccentricity may be used to sufficiently approximate the positional gain adjustment surface. Using this additional constant value, s_{xy}, the gain of a particular pixel (x,y) is determined in accordance with Equation (7):

$$cosh ( r ) \approx 1 + \frac{{( {s}_{x} ( x - {c}_{x} ) )}^{2} + {( {s}_{y} ( y - {c}_{y} ) )}^{2} + {s}_{xy} ( x - {c}_{x} ) ( y - {c}_{ y} )}{2} + \frac{{( {( {s}_{x} ( x - {c}_{x} ) )}^{2} + {( {s}_{y} ( y - {c}_{y} ) )}^{2} + {s}_{xy} ( x - {c}_{x} ) ( y - {c}_{y} ) )}^{2}}{24} \qquad ( 7 )$$

As can be seen in FIG. 5, using the rotated elliptical cosh method of approximating positional gain adjustment values results in a positional gain adjustment surface containing values that get monotonically larger towards the edge in every direction; thereby the largest values occur at the corners of the image. The contours of the positional gain adjustment surface generated using the elliptical cosh method remain elliptical as the gain increases towards the corners. However, unlike in the elliptical cosh method, the major and minor axes of the ellipse created using the rotated elliptical cosh method will not coincide with the x- and y-axes directions of the image.

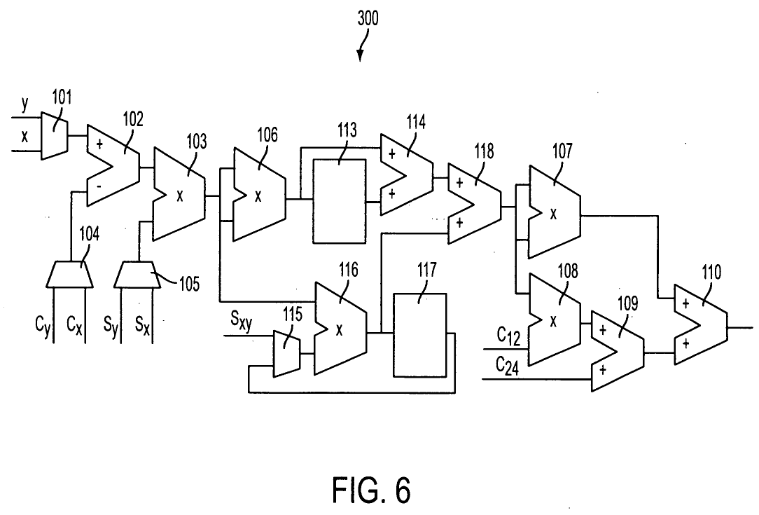

FIG. 6 illustrates a block diagram of an example circuit 300 implementing the rotated elliptical cosh method of the disclosed embodiment. The circuit 300 contains four multiplexers 101, 104, 105, 115, a subtractor 102, four adders 109, 110, 114, 118, five multipliers 103, 106, 107, 108, 116, and two registers 113, 117. Inputs c_{y}, cₓ, s_{y}, sₓ, s_{xy} are the constants discussed above and determined in accordance with the trial-and-error calibration method. Inputs C₁₂ and c₂₄ are also constants, previously discussed. Input y is the number of the row in which the pixel is located, i.e., the vertical position of the pixel within the image. Input x is the number of the column in which the pixel is located, i.e., the horizontal position of the pixel within the image.

Assuming a monochrome line-by-line image scan, the operation of the circuit 300 is now described. At the start of the readout of each row, during the horizontal blanking period, multiplexers 101, 104 and 105 are controlled so that they are all in the y-position. The output of subtractor 102 is (y−c_{y}) and the output of multiplier 103 is (s_{y}(y−c_{y})). Multiplier 106 squares this result (e.g., s_{y}²(y−c_{y})²) and the squared result is input into register 113, where it is held for the active part of the line. Also during the blanking period, multiplier 116 multiplies the output of multiplier 103 (s_{y}(y−c_{y})) by the constant say and the result (s_{xy}s_{y}(y−c_{y})) is stored in register 117. In the active data period, three multiplexers 101, 104, 105 are switched to the x-position. Subtractor 102 and multipliers 103 and 106 work to produce the square of the scaled offset x value (e.g., sₓ²(x−cₓ)²) in the same manner in which the scaled offset y value is determined. The two squared values are then added together in adder 114, resulting in the value (sₓ²(x−cₓ)²+s_{y}²(y−c_{y})²). The value of register 117 does not change during the active data period, but is input into multiplier 116 through multiplexer 115 resulting in an output from multiplier 116 of s_{xy}sₓ(y−c_{y})(x−cₓ). The output of multiplexer 116 is then added to the output of adder 114 using adder 118, resulting in the value of r² (in accordance with Equation (6)).

The output of adder 118 is input into both inputs of multiplier 107 producing the 4th power of the radius (r⁴) and simultaneously into constant multiplier 108, which multiplies the squared term by the constant c₂. The output from multiplier 108 is added to constant c₂₄ in adder 109, the output of which is added to the output of multiplier 107 in adder 110. The output of adder 110 is r⁴+c₁₂(r)²+c₂₄ where r² can be determined in accordance with Equation (6). The output of adder 110 is the positional gain adjustment value for the pixel (x,y) and is multiplied by the value of the pixel signal in accordance with Equation (1), resulting in the corrected pixel signal value.

“Rotated Elliptical Polynomial” Gain Adjustment Approximation:

In a further disclosed embodiment, the positional gain adjustment surface is approximated by a polynomial which is derived from the rotated elliptical cosh. This method will be referred to throughout as the “rotated elliptical polynomial” method. For the rotated elliptical polynomial method, the radius equation for the rotated elliptical cosh method (Equation (6)) is scaled by a factor of (1/sₓ), resulting in a scaled radius in accordance with Equation (8):

r′²=(x−cₓ)²+k₁(y−c_{y})²+k₂(x−cₓ)(y−c_{y}); (8)

where, r′ is the scaled radius, cₓ is the constant center value in the x-direction, c_{y} is the constant center value in the y-direction, k₁ represents the relative scaling between the horizontal and vertical gain surface and k₂ represents the diagonal scaling between opposite corners. It should again be noted that cₓ and c_{y} are based on the center of the correction surface for the image, but not necessarily on the center of the image array itself. Also, the value of k₁ is generally close to one and the value of k₂ is generally close to zero.

The gain for a particular pixel (x,y) is determined in accordance with Equation (9):

G(r′)=1+g₁(r′)²+g₂(r′)⁴; (9)

where the function G is the gain of the pixel having a scaled radius of r′ in accordance with Equation (8) and g₁ and g₂ are the gains of the second and fourth powers of the radius. Given that the radius is unscaled with respect to x, these values are in general small but highly variable in order of magnitude. Equation (9) is the result of a relaxing of the relationship among the terms of the cosh function. This relaxing allows a further simplification in that there is no longer the possibility that the function can result in a square root of zero, as can happen if the s_{xy} constant is not carefully chosen.

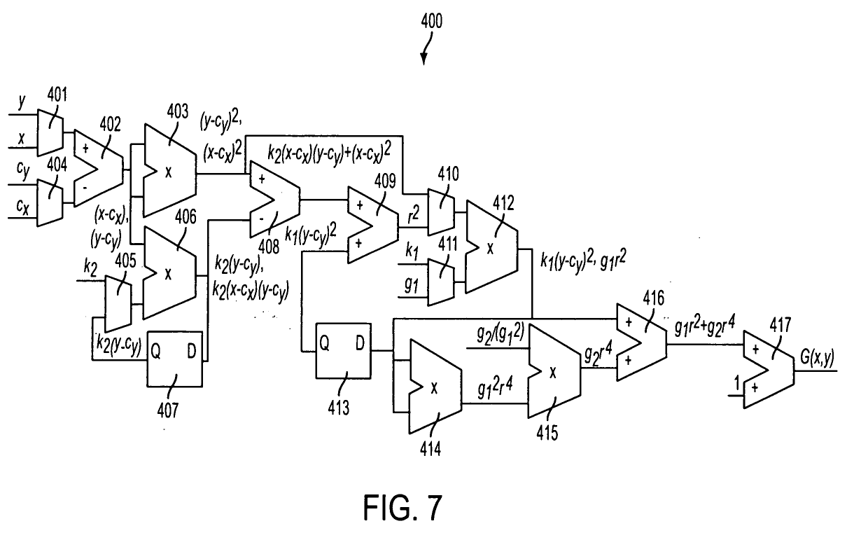

FIG. 7 illustrates a block diagram for an example circuit 400 implementing the rotated elliptical polynomial method of the disclosed embodiment. The circuit 400 contains multiplexers five 401, 404, 405, 410, 411, a subtractor 402, four adders 408, 409, 416, 417, five multipliers 403, 406, 412, 414, 415, and two registers 407, 413. Inputs c_{y}, cₓ, k₁, k₂, g₁ and g₂ are the constants discussed above and determined in accordance with the trial-and-error calibration method. Input y is the number of the row in which the pixel is located, i.e., the vertical position of the pixel within the image. Input x is the number of the column in which the pixel is located, i.e., the horizontal position of the pixel within the image.

Assuming a monochrome line-by-line scan, the operation of the circuit 400 is now described. At the start of the readout of each row, during the horizontal blanking period, the five multiplexers 401, 404, 405, 410, 411 are controlled so that they all input their upper input. The output of subtractor 402 is (y−c_{y}) and the output of multiplier 403 is ((y−c_{y})²), which is input into multiplier 412 via multiplexer 410, resulting in a value of (k₁(y−c_{y})²) which is stored in register 413, where it is held for the active part of the line. The output of multiplier 406 is k₂(y−c_{y}) which is stored in register 407, where it is held for the active part of the line.

In the active data period, multiplexers 401, 404, 405, 410 and 411 are controlled so that they all input their lower input. The output of subtractor 402 is (x−cₓ) and the output of multiplier 403 is ((x−cₓ)²). The value stored in register 407 is multiplied by the output of subtractor 402 in multiplier 406, resulting in a value of (k₂(x−cₓ)(y−c_{y})), which is input into adder 408 along with the output of multiplier 403, resulting in a value of (k₂(x−cₓ)(y−c_{y})+(x−cₓ)²) which is input into adder 409 along with the value stored in register 413, resulting in ((x−cₓ)²+k₁(y−c_{y})²+k₂(x−cₓ)(y−c_{y})) or r′². The r′² value is input into multiplier 412 along with the constant value g₁ (multiplexer 411). The output of multiplier 412 is input into both inputs of multiplier 414, resulting in the value (g₁²r′⁴). This value output from multiplier 414 is then input into multiplier 415 along with a constant value of g₂/(g₁²) resulting in (g₂r′⁴). This value is input into adder 416 along with the output of multiplier 412, resulting in a value of (g₁r′²+g₂r′⁴) that is input into adder 417 along with a constant value of 1. The output of adder 417 is the equation for the gain of the pixel value in accordance with Equation (9). The output of adder 410 is the positional gain adjustment value for the pixel (x,y) and is multiplied by the value of the pixel signal in accordance with Equation (1), resulting in the corrected pixel signal value.

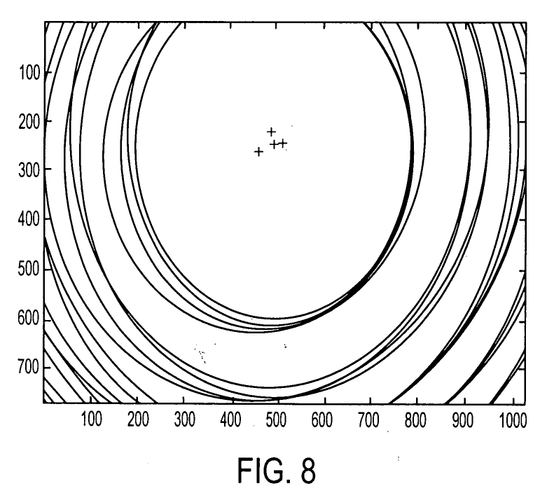

It should be noted that although for each of the embodiments, the operation is described with reference to a monochrome image, that the disclosed embodiments are intended to be implemented for each color channel of an image. For each color channel, the necessary constants (depending on the chosen method) are independently calibrated using the trial-and-error method of calibration. The trial-and-error method of calibration involves repeatedly choosing a parameter at random, changing it by a random amount and accepting the new result if it was better than the old result, using the least squared error from the mean level as the criterion. It should also be noted that the parameters representing the center of the correction surface (cₓ and c_{y}) will likely be different for each color channel of the image, as shown for example, in FIG. 8, which is an illustration of the shapes of the rotated elliptical correction functions, overlaid for comparison.

It should further be noted that although the disclosed embodiments for gain adjustment have been described with reference to hardware solutions, that the embodiments may also be implemented by a processor executing a program, or by a combination of a hardware solution and a processor. The correction methods may also be implemented as computer instructions and stored on a computer readable storage medium for execution by a computer or processor which processes raw pixel value from a pixel array, with the result being stored in an imager for use by an image processor circuit.

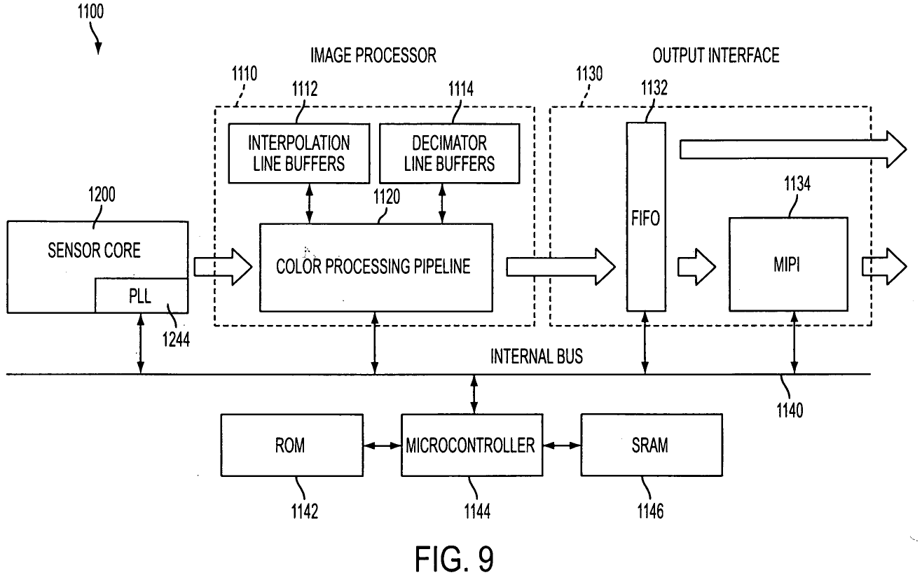

FIG. 9 illustrates a block diagram of a system-on-a-chip (SOC) imager 1100 constructed in accordance with disclosed embodiments. The system-on-a-chip imager 1100 may use any type of imager technology, CCD, CMOS, etc.

The imager 1100 comprises a sensor core 1200 that communicates with an image processor 1110 that is connected to an output interface 1130. A phase lock loop (PLL) 1244 is used as a clock for the sensor core 1200. The image processor 1110, which is responsible for image and color processing, includes interpolation line buffers 1112, decimator line buffers 1114, and a color processing pipeline 1120. One of the functions of the color processing pipeline 1120 is the performance of pixel signal value correction in accordance with the disclosed embodiments, discussed above.

The output interface 1130 includes an output first-in-first-out (FIFO) parallel buffer 1132 and a serial Mobile Industry Processing Interface (MIPI) output 1134, particularly where the imager 1100 is used in a camera in a mobile telephone environment. The user can select either a serial output or a parallel output by setting registers in a configuration register within the imager 1100 chip. An internal bus 140 connects read only memory (ROM) 1142, a microcontroller 1144, and a static random access memory (SRAM) 1146 to the sensor core 1200, image processor 1110, and output interface 1130. The read only memory (ROM) 1142 may serve as a storage location for the constants used to generate the correction values, in accordance with disclosed embodiments.

As noted, disclosed embodiments may be implemented as part of an image processor 1110 and can be implemented using hardware components including an ASIC, a processor executing a program, or other signal processing hardware and/or processor structure or any combination thereof.

Disclosed embodiments may be implemented as part of a camera such as e.g., a digital still or video camera, or other image acquisition system, and may also be implemented as stand-alone software or as a plug-in software component for use in a computer, such as a personal computer, for processing separate images. In such applications, the process can be implemented as computer instruction code contained on a storage medium for use in the computer image-processing system.

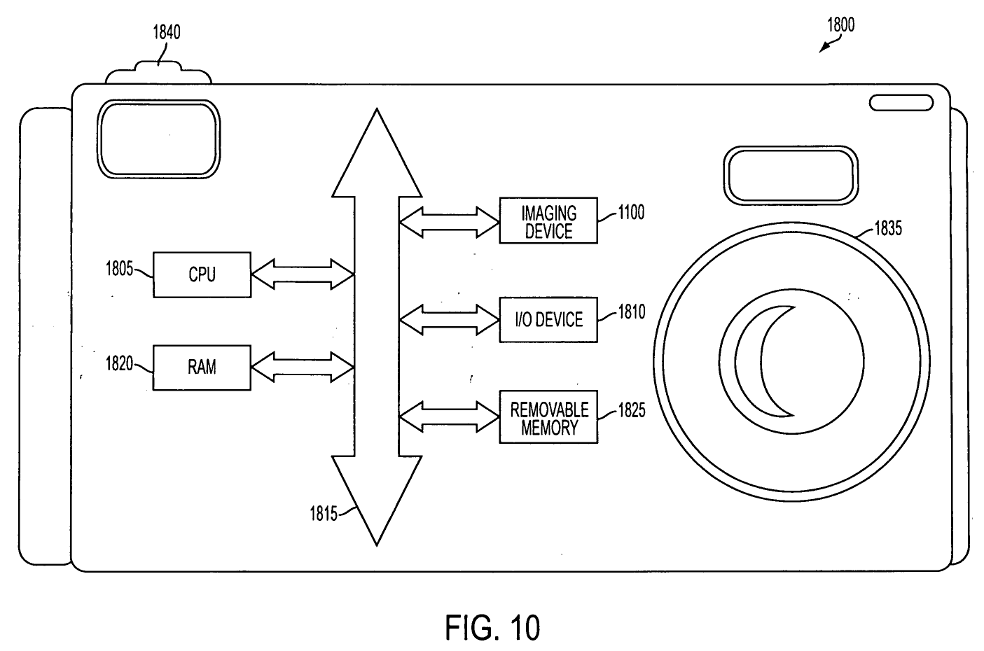

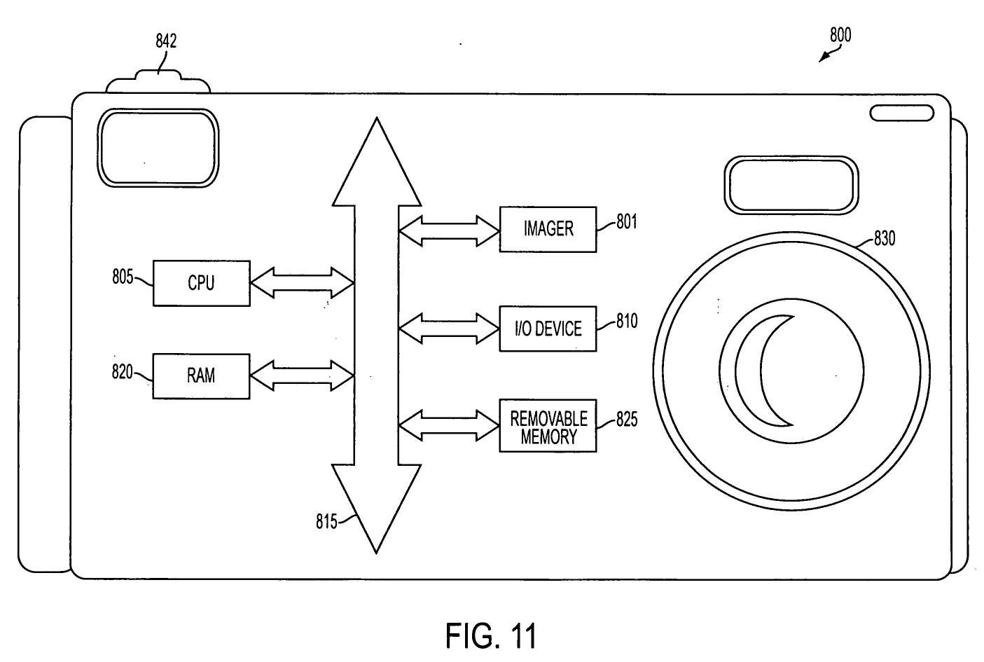

For example, FIG. 10 illustrates a processor system as part of a digital still or video camera system 1800 employing a system-on-a-chip imager 1100 as illustrated in FIG. 9.I Imager 1100 provides for positional gain adjustment and/or other pixel value corrections using vertical and horizontal correction value curves, as described above. The processing system 1800 includes a processor 1805 (shown as a CPU) which implements system, e.g. camera 1800, functions and also controls image flow and image processing. The processor 1805 is coupled with other elements of the system, including random access memory 1820, removable memory 825 such as a flash or disc memory, one or more input/output devices 1810 for entering data or displaying data and/or images and imager 1100 through bus 1815 which may be one or more busses or bridges linking the processor system components. A lens 1835 allows images of an object being viewed to pass to the imager 1100 when a “shutter release”/“record” button 1840 is depressed.

The camera system 1800 is an example of a processor system having digital circuits that could include image sensor devices. Without being limiting, such a system could also include a computer system, cell phone system, scanner system, machine vision system, vehicle navigation system, video phone, surveillance system, star tracker system, motion detection system, image stabilization system, and other image processing systems.

Although the disclosed embodiments employ a pixel processing circuit, e.g., image processor 1110, which is part of an imager 1100, the pixel processing described above may also be carried out on a stand-alone computer in accordance with software instructions and vertical and horizontal correction value curves and any other parameters stored on any type of storage medium.

While several embodiments have been described in detail, it should be readily understood that the invention is not limited to the disclosed embodiments. Rather the disclosed embodiments can be modified to incorporate any number of variations, alterations, substitutions or equivalent arrangements not heretofore described.

What is claimed as new and desired to be protected by Letters Patent of the United States is:

1. A method of correcting sensitivity of a plurality of pixel signals associated with a pixel array and forming an image, the method comprising:
calculating a plurality of correction values corresponding to the pixel signals, the plurality of correction values comprising a correction surface; and
applying the respective correction values to the pixel signals to form an output image,
wherein the correction value for each pixel signal is calculated using an approximation of an elliptical hyperbolic cosine function based on the location of a pixel in the pixel array corresponding to the pixel signal.

2. The method of claim 1, wherein the elliptical hyperbolic cosine function is further based on vertical and horizontal center positions of the correction surface and vertical and horizontal scaling factors.

3. The method of claim 2, wherein the vertical and horizontal center positions and the vertical and horizontal scaling factors are constant values that are determined during calibration.

4. The method of claim 3, wherein the constant values vary among color channels of the image.

5. The method of claim 1, wherein the correction value for each pixel signal is further based on a rotated elliptical hyperbolic cosine correction parameter.

6. The method of claim 5, wherein the rotated elliptical hyperbolic cosine correction parameter is a scaling factor that acts to move the axes of the ellipse away from the x- and y-axes.

7. The method of claim 1, wherein the correction values are positional gain adjustment values.

8. A method of correcting sensitivity of a plurality of pixel signals associated with a pixel array, the method comprising:
calculating a plurality of correction values corresponding to the pixel signals; and
applying the respective correction value to the pixel signals to form an output image,
wherein the correction value for each pixel signal is calculated using an approximation of a hyperbolic cosine function based on a radius function representing the radius of an ellipse.

9. The method of claim 8, wherein the radius function is r²=(sₓ(x−cₓ))²+(s_{y}(y−c_{y}))², and
wherein r is the radius of the ellipse, sₓ is a constant scaling factor in the x-direction, cₓ is a constant center value in the x-direction, s_{y} is a constant scaling factor in the y-direction and c_{y} is a constant center value in the y-direction.

10. The method of claim 8, wherein the radius function is r²=(sₓ(x−cₓ))²+(s_{y}(y−c_{y}))²+sₓs_{y}s_{xy}(x−cₓ)(y−c_{y}), and
wherein r is the radius of the ellipse, sₓ is a constant scaling factor in the x-direction, cₓ is a constant center value in the x-direction, s_{y} is a constant scaling factor in the y-direction, c_{y} is a constant center value in the y-direction and s_{xy} is a constant scaling factor that acts to move axes of the ellipse away from x- and y-axes.

11. A method of correcting sensitivity of a plurality of pixel signals associated with a pixel array, the method comprising:
calculating a plurality of correction values corresponding to the pixel signals; and
applying the respective correction value to the pixel signals to form an output image,
wherein the correction value for each pixel signal is calculated using a polynomial function that is derived from an approximation of a hyperbolic cosine function, wherein the hyperbolic cosine function is based on a first function representing a scaled radius of an ellipse.

12. The method of claim 11, wherein the first function is r′²=(x−cₓ)²+k₁(y−c_{y})²+k₂(x−cₓ)(y−c_{y}) and wherein r′ is the scaled radius, cₓ is a constant center value in the x-direction, c_{y} is a constant center value in the y-direction, k₁ represents a relative scaling between horizontal and vertical gain surfaces and k₂ represents diagonal scaling between opposite corners.

13. An imaging device comprising:
a pixel array, the pixel array outputting a plurality of pixel signal values; and
an image processing unit coupled to the pixel array, the image processing unit being operable to correct a responsiveness of pixels in the pixel array by applying respective correction values to the pixel signal values, the respective correction values comprising a correction surface,
wherein a correction value for a particular pixel value is determined using an approximation of an elliptical hyperbolic cosine function that is based on constants stored on-chip.

14. The imaging device of claim 13, wherein the stored constants include the location of the particular pixel in the pixel array, vertical and horizontal center positions of the correction surface and vertical and horizontal scaling factors.

15. The imaging device of claim 14, wherein the vertical and horizontal center positions and the vertical and horizontal scaling factors are constant values that are determined during calibration of the imaging device.

16. The imaging device of claim 15, wherein the constant values vary among color channels of the image.

17. The imaging device of claim 14, wherein the correction value for each pixel signal is further based on a rotated elliptical hyperbolic cosine correction parameter.

18. The imaging device of claim 17, wherein the rotated elliptical hyperbolic cosine correction parameter is a scaling factor that acts to move the axes of the ellipse away from the x- and y-axes.

19. The imaging device of claim 13, wherein the correction values are positional gain adjustment values.

20. An imaging device comprising:
a pixel array, the pixel array outputting a plurality of pixel signal values; and
an image processing unit coupled to the pixel array, the image processing unit being operable to correct a responsiveness of pixels in the pixel array by applying respective correction values to the pixel signal values, the respective correction values comprising a correction surface,
wherein a correction value for a particular pixel value is determined based on stored constants representing a radius function calculating the radius of an ellipse which is used in an elliptical hyperbolic cosine function to determine the correction value.

21. The imaging device of claim 20, wherein the stored constants are stored on-chip.

22. The imaging device of claim 20, wherein the radius function is r²=(sₓ(x−cₓ))²+(s_{y}(y−c_{y}))², and
wherein r is the radius of the ellipse, sₓ is a constant scaling factor in the x-direction, cₓ is a constant center value in the x-direction, s_{y} is a constant scaling factor in the y-direction and c_{y} is a constant center value in the y-direction.

23. The imaging device of claim 20, wherein the radius function is r²=(sₓ(x−cₓ))²+(s_{y}(y−c_{y}))²+sₓs_{y}s_{xy}(x−cₓ)(y−c_{y}), and
wherein r is the radius of the ellipse, sₓ is a constant scaling factor in the x-direction, cₓ is a constant center value in the x-direction, s_{y} is a constant scaling factor in the y-direction, c_{y} is a constant center value in the y-direction and s_{xy} is a constant scaling factor that acts to move axes of the ellipse away from x- and y-axes.

24. The imaging device of claim 20, wherein the radius function is r′²=(x−cₓ)²+k₁(y−c_{y})²+k₂(x−cₓ)(y−c_{y}),
wherein r′ is a scaled radius, cₓ is a constant center value in the x-direction, c_{y} is a constant center value in the y-direction, k₁ represents a relative scaling between horizontal and vertical gain surfaces and k₂ represents diagonal scaling between opposite corners, and
wherein a relationship between terms of the elliptical hyperbolic cosine function is relaxed such that the correction value is determined as G(r′)=1+g₁(r′)²+g₂(r′)⁴ where the function G is the correction value of the particular and g₁ and g₂ are the gains of the second and fourth powers of the sealed radius.

25. The imaging device of claim 20, wherein said imaging device is part of a camera system.
